(19) United States
(12) Patent Application Publication
(10) Pub. No.: US 2025/0016769 A1
(43) Pub. Date: Jan. 9, 2025

(54) SCHEDULING FOR SERVICES WITH MULTIPLE PRIORITY TYPES

(71) Applicant: Samsung Electronics Co., Ltd., Suwon-si (KR)

(72) Inventor: Aris Papasakellariou, Houston, TX (US)

(21) Appl. No.: 18/886,845

(22) Filed: Sep. 16, 2024

Related U.S. Application Data
(63) Continuation of application No. 16/923,948, filed on Jul. 8, 2020.
(60) Provisional application No. 62/879,591, filed on Jul. 29, 2019.

(51) Int. Cl. H04W 72/1273; H04L 1/1812; H04W 72/23

(52) U.S. Cl. CPC H04W 72/1273; H04L 1/1812; H04W 72/23

(57) ABSTRACT

Methods and apparatuses for transmitting and receiving information of different priorities. A method of operating a UE includes receiving a first PDCCH providing a first DCI format. The first DCI format schedules a reception of a PDSCH, includes an MCS field, and includes a priority indicator field. The method further includes determining an MCS table, from a first predetermined MCS table or a second predetermined MCS table, based on a value of the priority indicator field in the first DCI format; determining a modulation order and a code rate from the MCS table based on a value of the MCS field; receiving a TB in the PDSCH according to the modulation order and the code rate; and determining a priority of HARQ-ACK information in response to the TB reception based on the value of the priority indicator field in the first DCI format.

### CROSS-REFERENCE TO RELATED APPLICATIONS AND CLAIM OF PRIORITY

This application is a continuation of U.S. patent application Ser. No. 16/923,948, filed on Jul. 8, 2020, which claims priority to U.S. Provisional Patent Application No. 62/879,591, filed on Jul. 29, 2019. The content of the above-identified patent document is incorporated herein by reference.

### TECHNICAL FIELD

The present disclosure relates generally to wireless communication systems and, more specifically, to supporting channel state information (CSI) feedback for support of multiple services from a user equipment (UE) to a serving base station.

### BACKGROUND

5th generation (5G) or new radio (NR) mobile communications, initial commercialization of which is expected around 2020, is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

The present disclosure relates to wireless communication systems and, more specifically, to supporting CSI feedback for support of multiple services from a UE to a serving base station.

In one embodiment, a UE is provided. The UE includes a transceiver configured to receive a first physical downlink control channel (PDCCH) providing a first downlink control information (DCI) format. The first DCI format schedules a reception of a physical downlink shared channel (PDSCH), includes a modulation and coding (MCS) field, and includes a priority indicator field. The UE further includes a processor operably connected to the transceiver. The processor is configured to determine an MCS table, from a first predetermined MCS table or a second predetermined MCS table, based on a value of the priority indicator field in the first DCI format and a modulation order and a code rate from the MCS table based on a value of the MCS field. The transceiver is further configured to receive a transport block (TB) in the PDSCH according to the modulation order and the code rate. The processor is further configured to determine a priority of hybrid automatic repeat request acknowledgement (HARQ-ACK) information in response to the TB reception based on the value of the priority indicator field in the first DCI format.

In another embodiment, a base station is provided. The base station includes a transceiver configured to transmit a first PDCCH providing a first DCI format. The first DCI format schedules a transmission of a PDSCH, includes an MCS field, and includes a priority indicator field. The base station further includes a processor operably connected to the transceiver. The processor is configured to determine: an MCS table, from a first predetermined MCS table or a second predetermined MCS table, based on a value of the priority indicator field in the first DCI format; and a modulation order and a code rate from the MCS table based on a value of the MCS field. The transceiver is further configured to transmit a TB in the PDSCH according to the modulation order and the code rate. A priority of HARQ-ACK information in response to the TB transmission is based on the value of the priority indicator field in the first DCI format.

In yet another embodiment, a method for transmitting and receiving information of different priorities by a UE is provided. The method includes receiving a first PDCCH providing a first DCI format. The first DCI format schedules a reception of a PDSCH, includes an MCS field, and includes a priority indicator field. The method further includes determining an MCS table, from a first predetermined MCS table or a second predetermined MCS table, based on a value of the priority indicator field in the first DCI format; determining a modulation order and a code rate from the MCS table based on a value of the MCS field; receiving a TB in the PDSCH according to the modulation order and the code rate; and determining a priority of HARQ-ACK information in response to the TB reception based on the value of the priority indicator field in the first DCI format.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNB according to embodiments of the present disclosure;

FIG. 3 illustrates an example UE according to embodiments of the present disclosure;

FIG. 4 illustrates an example DL slot structure according to embodiments of the present disclosure;

FIG. 5 illustrates an example UL slot structure for PUSCH transmission or PUCCH transmission according to embodiments of the present disclosure;

FIG. 6 illustrates an example wireless transmit path according to embodiments of the present disclosure;

FIG. 7 illustrates an example wireless receive path according to embodiments of the present disclosure;

FIG. 8 illustrates a flow chart of UE procedure to provide a first CQI report and a second CQI report according to embodiments of the present disclosure;

FIG. 9 illustrates a flow chart of UE procedure to provide a first CQI report and a second CQI report in a same CSI report according to embodiments of the present disclosure;

FIG. 10 illustrates a flow chart of UE procedure to determine a CSI report to transmit in a PUCCH, when the UE is configured to transmit multiple CSI reports in respective multiple PUCCHs in resources that overlap in time, according to embodiments of the present disclosure;

FIG. 11 illustrates a flow chart of UE procedure to determine an A-CSI report triggering in a PUSCH transmission on in a PUCCH transmission based on a detection of a DCI format that is also used to schedule a PDSCH reception, according to embodiments of the present disclosure; and

FIG. 12 illustrates a flow chart of UE procedure to determine whether to multiplex UCI in a PUSCH or in a PUCCH when the UE would simultaneously transmit the PUSCH and the PUCCH according to embodiments of the present disclosure.

### DETAILED DESCRIPTION

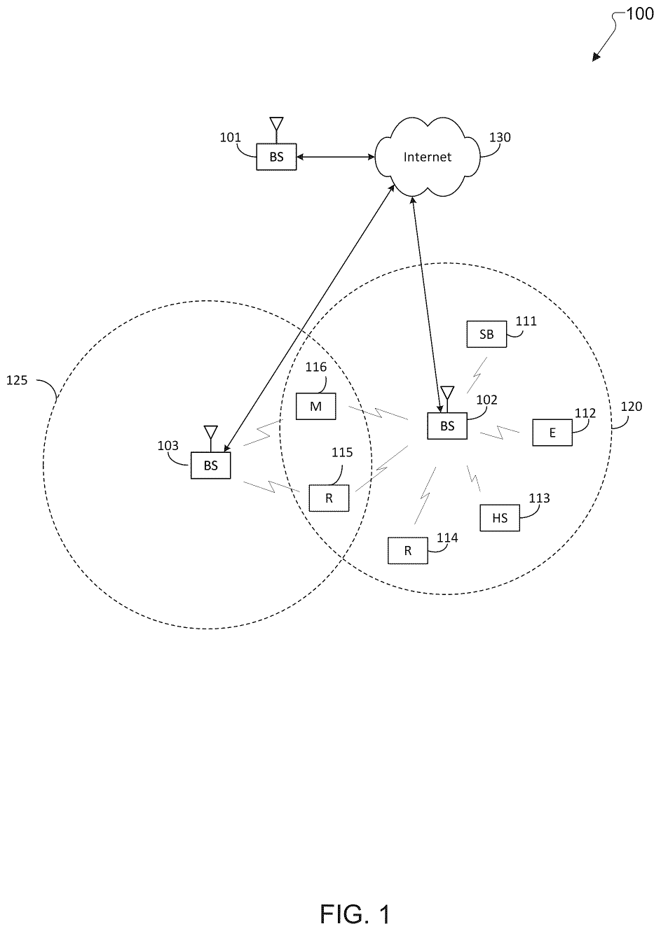

FIGS. 1 through FIG. 12, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following documents are hereby incorporated by reference into the present disclosure as if fully set forth herein: 3GPP TS 38.211 v15.6.0, “NR; Physical channels and modulation;” 3GPP TS 38.212 v15.6.0, “NR; Multiplexing and Channel coding;” 3GPP TS 38.213 v15.6.0, “NR; Physical Layer Procedures for Control;” 3GPP TS 38.214 v15.6.0, “NR; Physical Layer Procedures for Data;” 3GPP TS 38.321 v15.6.0, “NR; Medium Access Control (MAC) protocol specification;” and 3GPP TS 38.331 v15.6.0, “NR; Radio Resource Control (RRC) Protocol Specification.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably-arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business (SB); a UE 112, which may be located in an enterprise (E); a UE 113, which may be located in a WiFi hotspot (HS); a UE 114, which may be located in a first residence (R); a UE 115, which may be located in a second residence (R); and a UE 116, which may be a mobile device (M), such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, LTE, LTE-A, WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3GPP new radio interface/access (NR), long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for efficient CSI reporting for multiple services in new radio systems. In certain embodiments, and one or more of the gNBs 101-103 includes circuitry, programing, or a combination thereof, for efficient CSI reporting for multiple services in new radio systems.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

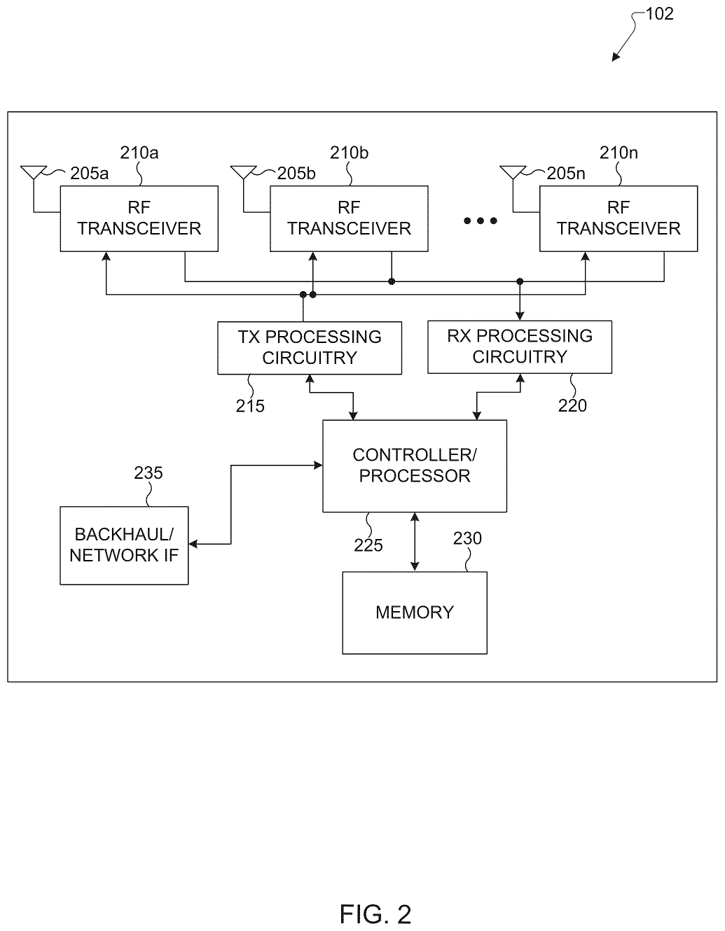

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple RF transceivers 210a-210n, transmit (TX) processing circuitry 215, and receive (RX) processing circuitry 220. The gNB 102 also includes a controller/processor 225, a memory 230, and a backhaul or network interface 235.

The RF transceivers 210a-210n receive, from the antennas 205a-205n, incoming RF signals, such as signals transmitted by UEs in the network 100. The RF transceivers 210a-210n down-convert the incoming RF signals to generate IF or baseband signals. The IF or baseband signals are sent to the RX processing circuitry 220, which generates processed baseband signals by filtering, decoding, and/or digitizing the baseband or IF signals. The RX processing circuitry 220 transmits the processed baseband signals to the controller/processor 225 for further processing.

The TX processing circuitry 215 receives analog or digital data (such as voice data, web data, e-mail, or interactive video game data) from the controller/processor 225. The TX processing circuitry 215 encodes, multiplexes, and/or digitizes the outgoing baseband data to generate processed baseband or IF signals. The RF transceivers 210a-210n receive the outgoing processed baseband or IF signals from the TX processing circuitry 215 and up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of forward channel signals and the transmission of reverse channel signals by the RF transceivers 210a-210n, the RX processing circuitry 220, and the TX processing circuitry 215 in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as an OS. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or RF transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. As a particular example, an access point could include a number of interfaces 235, and the controller/processor 225 could support routing functions to route data between different network addresses. As another particular example, while shown as including a single instance of TX processing circuitry 215 and a single instance of RX processing circuitry 220, the gNB 102 could include multiple instances of each (such as one per RF transceiver). Also, various components in FIG. 2 could be combined, further subdivided, or omitted and additional components could be added according to particular needs.

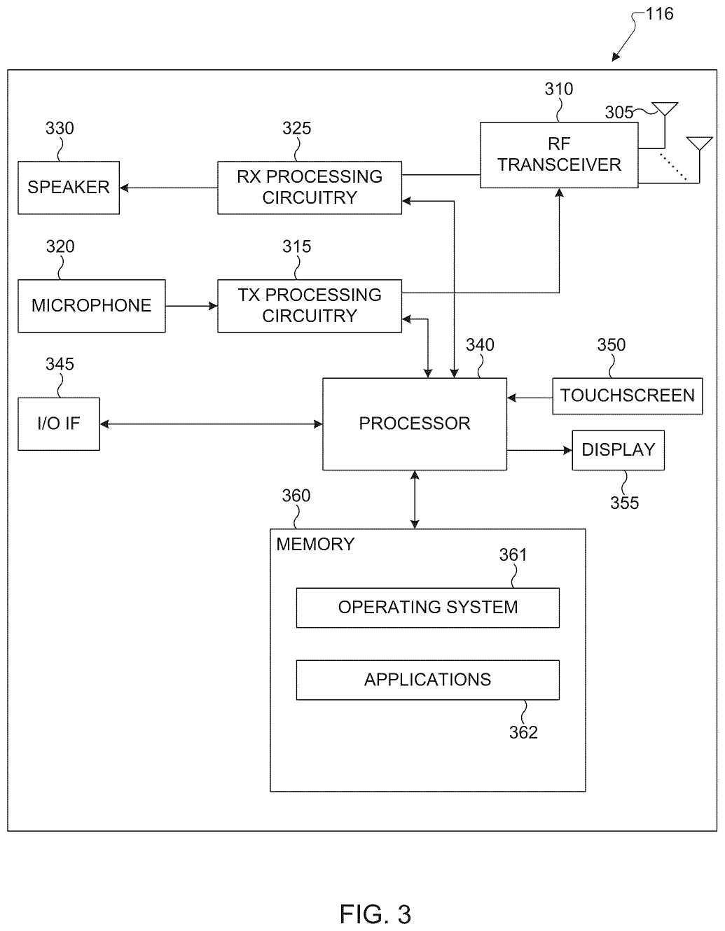

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes an antenna 305, a radio frequency (RF) transceiver 310, TX processing circuitry 315, a microphone 320, and receive (RX) processing circuitry 325. The UE 116 also includes a speaker 330, a processor 340, an input/output (I/O) interface (IF) 345, a touchscreen 350, a display 355, and a memory 360. The memory 360 includes an operating system (OS) 361 and one or more applications 362.

The RF transceiver 310 receives, from the antenna 305, an incoming RF signal transmitted by a gNB of the network 100. The RF transceiver 310 down-converts the incoming RF signal to generate an intermediate frequency (IF) or baseband signal. The IF or baseband signal is sent to the RX processing circuitry 325, which generates a processed baseband signal by filtering, decoding, and/or digitizing the baseband or IF signal. The RX processing circuitry 325 transmits the processed baseband signal to the speaker 330 (such as for voice data) or to the processor 340 for further processing (such as for web browsing data).

The TX processing circuitry 315 receives analog or digital voice data from the microphone 320 or other outgoing baseband data (such as web data, e-mail, or interactive video game data) from the processor 340. The TX processing circuitry 315 encodes, multiplexes, and/or digitizes the outgoing baseband data to generate a processed baseband or IF signal. The RF transceiver 310 receives the outgoing processed baseband or IF signal from the TX processing circuitry 315 and up-converts the baseband or IF signal to an RF signal that is transmitted via the antenna 305.

The processor 340 can include one or more processors or other processing devices and execute the OS 361 stored in the memory 360 in order to control the overall operation of the UE 116. For example, the processor 340 could control the reception of forward channel signals and the transmission of reverse channel signals by the RF transceiver 310, the RX processing circuitry 325, and the TX processing circuitry 315 in accordance with well-known principles. In some embodiments, the processor 340 includes at least one microprocessor or microcontroller.

The processor 340 is also capable of executing other processes and programs resident in the memory 360, such as processes for beam management. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the touchscreen 350 and the display 355. The operator of the UE 116 can use the touchscreen 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). Also, while FIG. 3 illustrates the UE 116 configured as a mobile telephone or smartphone, UEs could be configured to operate as other types of mobile or stationary devices.

To meet the demand for wireless data traffic having increased since deployment of 4G communication systems, efforts have been made to develop an improved 5G/NR or pre-5G/NR communication system. Therefore, the 5G/NR or pre-5G/NR communication system is also called a “beyond 4G network” or a “post LTE system.” The 5G/NR communication system is considered to be implemented in higher frequency (mmWave) bands, e.g., 60 GHz bands, so as to accomplish higher data rates, or in lower frequency bands, such as below 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems. In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancellation and the like.

A communication system includes a downlink (DL) that refers to transmissions from a base station or one or more transmission points to UEs and an uplink (UL) that refers to transmissions from UEs to a base station or to one or more reception points.

A time unit for DL signaling or for UL signaling on a cell is referred to as a slot and can include one or more symbols. A symbol can also serve as an additional time unit. A frequency (or bandwidth (BW)) unit is referred to as a resource block (RB). One RB includes a number of sub-carriers (SCs). For example, a slot can have duration of 0.5 milliseconds or 1 millisecond, include 14 symbols and an RB can include 12 SCs with inter-SC spacing of 15 KHz or 30 KHz, and so on. One RB over one symbol is referred as physical RB (PRB).

DL signals include data signals conveying information content, control signals conveying DL control information (DCI), and reference signals (RS) that are also known as pilot signals. A gNB transmits data information or DCI through respective physical DL shared channels (PDSCHs) or physical DL control channels (PDCCHs). A PDSCH or a PDCCH can be transmitted over a variable number of slot symbols including one slot symbol. For brevity, a DCI format scheduling a PDSCH reception by a UE is referred to as a DL DCI format and a DCI format scheduling a PUSCH transmission from a UE is referred to as an UL DCI format.

A gNB transmits one or more of multiple types of RS including channel state information RS (CSI-RS) and demodulation RS (DMRS). A CSI-RS is primarily intended for UEs to perform measurements and provide channel state information (CSI) to a gNB. For channel measurement, non-zero power CSI-RS (NZP CSI-RS) resources are used. For interference measurement reports (IMRs), CSI interference measurement (CSI-IM) resources associated with a zero power CSI-RS (ZP CSI-RS) configuration are used. A CSI process consists of NZP CSI-RS and CSI-IM resources.

A UE can determine CSI-RS transmission parameters through DL control signaling or higher layer signaling, such as radio resource control (RRC) signaling, from a gNB. Transmission instances of a CSI-RS can be indicated by DL control signaling or be configured by higher layer signaling. A DMRS is transmitted only in the BW of a respective PDCCH or PDSCH and a UE can use the DMRS to demodulate data or control information.

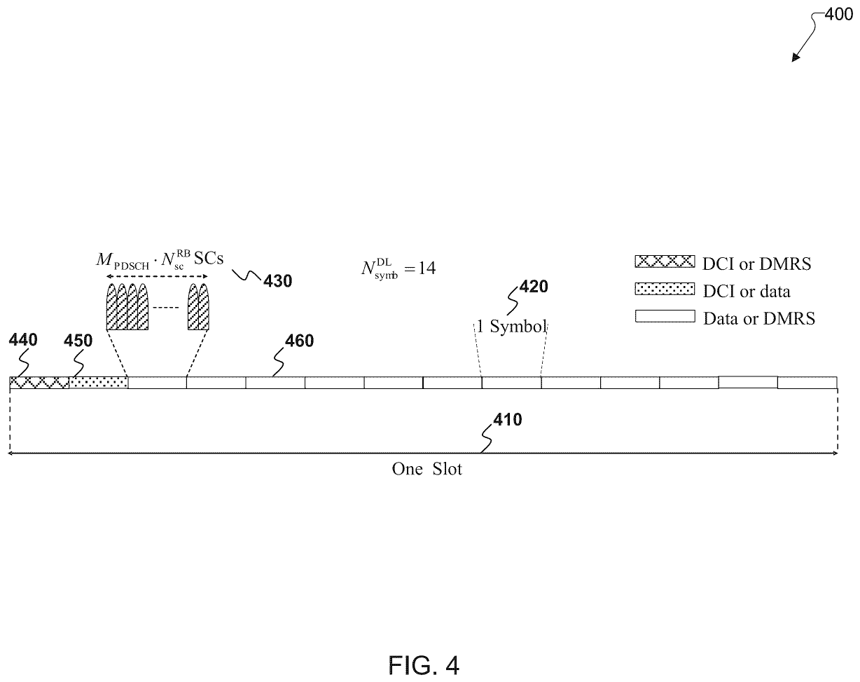

FIG. 4 illustrates an example DL slot structure 400 according to embodiments of the present disclosure. The embodiment of the DL slot structure 400 illustrated in FIG. 4 is for illustration only and could have the same or similar configuration. FIG. 4 does not limit the scope of this disclosure to any particular implementation.

A DL slot 410 includes N_{symb}^{DL} symbols 420 where a gNB can transmit data information, DCI, or DMRS. A DL system BW includes N_{RB}^{DL} RBs. Each RB includes NR_{sc}^{RB} SCs. A UE is assigned M_{PDSCH} RBs for a total of M_{sc}^{PDSCH}=M_{PDSCH}·N_{sc}^{RB} SCs 430 for a PDSCH transmission BW. A PDCCH conveying DCI is transmitted over control channel elements (CCEs) that are substantially spread across the DL system BW. A first slot symbol 440 can be used by the gNB to transmit PDCCH. A second slot symbol 450 can be used by the gNB to transmit PDCCH or PDSCH. Remaining slot symbols 460 can be used by the gNB to transmit PDSCH and CSI-RS. In some slots, the gNB can also transmit synchronization signals and channels that convey system information.

UL signals also include data signals conveying information content, control signals conveying UL control information (UCI), DMRS associated with data or UCI demodulation, sounding RS (SRS) enabling a gNB to perform UL channel measurement, and a random access (RA) preamble enabling a UE to perform random access. A UE transmits data information, also referred to as a transport block or UL shared channel (UL-SCH), or UCI through a respective physical UL shared channel (PUSCH) or a physical UL control channel (PUCCH). A PUSCH or a PUCCH can be transmitted over a variable number of symbols in a slot including one symbol.

UCI includes hybrid automatic repeat request acknowledgement (HARQ-ACK) information, indicating correct or incorrect detection of data transport blocks (TBs) in a PDSCH, scheduling request (SR) indicating whether or not a UE has data in the UE's buffer, and CSI reports enabling a gNB to select appropriate parameters for PDSCH or PDCCH transmissions to a UE. HARQ-ACK information can be configured to be with a smaller granularity than per TB and can be per code block (CB) or per group of CBs where a TB includes a number of CBs. When a PDSCH reception that provides a TB is scheduled by a DCI format, the DCI format can include a field indicating a slot for the PUCCH transmission with the HARQ-ACK information in response to the TB reception and a PUCCH resource for the PUCCH transmission. When parameters for a PDSCH reception that provides a TB are provided by higher layers, the higher layers can also provide a slot for the PUCCH transmission with the HARQ-ACK information in response to the TB reception and a PUCCH resource for the PUCCH transmission.

When a first PUCCH transmission with a first UCI (HARQ-ACK information, or SR, or CSI report) from a UE in a slot would overlap in time with a second PUCCH transmission with a second UCI in the slot, the UE can determine a new PUCCH resource to multiplex the first UCI type and the second UCI type in a third PUCCH transmission in the slot. The multiplexing is condition on predetermined timelines being fulfilled.

A CSI report from a UE can include a channel quality indicator (CQI) informing a gNB of a largest modulation and coding scheme (MCS) for the UE to detect a TB with a predetermined block error rate (BLER), such as a 10% BLER, by providing an index to an MCS Table, a precoding matrix indicator (PMI) informing a gNB how to combine signals from multiple transmitter antennas in accordance with a multiple input multiple output (MIMO) transmission principle, and a rank indicator (RI) indicating a transmission rank for a PDSCH. The CSI report can also include a CSI-RS resource indicator (CRI) to indicate a CSI-RS resource used for the measurements of the CSI report.

UL RS includes DMRS and SRS. DMRS is transmitted only in a BW of a respective PUSCH or PUCCH transmission. A gNB can use a DMRS to demodulate information in a respective PUSCH or PUCCH. SRS is transmitted by a UE to provide a gNB with an UL CSI and, for a TDD system, an SRS transmission can also provide a PMI for DL transmission. Additionally, in order to establish synchronization or an initial higher layer connection with a gNB, a UE can transmit a physical random access channel (PRACH).

When a UE would simultaneously transmit data information in a PUSCH and UCI in a PUCCH, the UE can multiplex both a TB for an UL-SCH and UCI in the PUSCH provided that a set of predetermined timeline conditions are satisfied so that the UE can cancel the PUCCH transmission and multiplex HARQ-ACK information or CSI in the PUSCH transmission. Similar, as previously mentioned, when a UE would simultaneously transmit a first PUCCH and a second PUCCH, the UE can multiplex all corresponding UCI in a third PUCCH provided that a set of predetermined timeline conditions are satisfied so that the UE can cancel the first and second PUCCH transmissions and multiplex the corresponding UCI in the third PUCCH transmission.

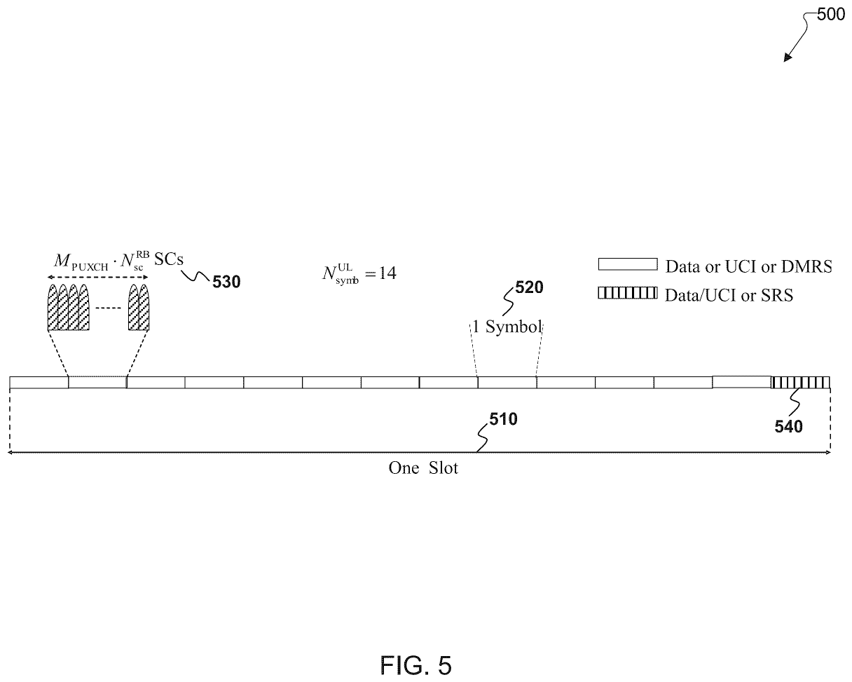

FIG. 5 illustrates an example UL slot structure 500 for PUSCH transmission or PUCCH transmission according to embodiments of the present disclosure. The embodiment of the UL slot structure 500 illustrated in FIG. 5 is for illustration only and could have the same or similar configuration. FIG. 5 does not limit the scope of this disclosure to any particular implementation.

As shown in FIG. 5, a slot 510 includes N_{symb}^{UL} symbols 520 where UE transmits data information, UCI, or DMRS. An UL system BW includes N_{RB}^{UL} RBs. Each RB includes N_{sc}^{RB} SCs. A UE is assigned M_{PUXCH} RBs for a total of M_{sc}^{PUXCH}=M_{PUXCH}·N_{sc}^{RB} RBs 530 for a PUSCH transmission BW (“X”=“S”) or for a PUCCH transmission BW (“X”=“C”). Last one or more symbols of a slot can be used to multiplex SRS transmissions 550 or short PUCCH transmissions from one or more UEs.

DL transmissions and UL transmissions can be based on an orthogonal frequency division multiplexing (OFDM) waveform including a variant using DFT precoding that is known as DFT-spread-OFDM.

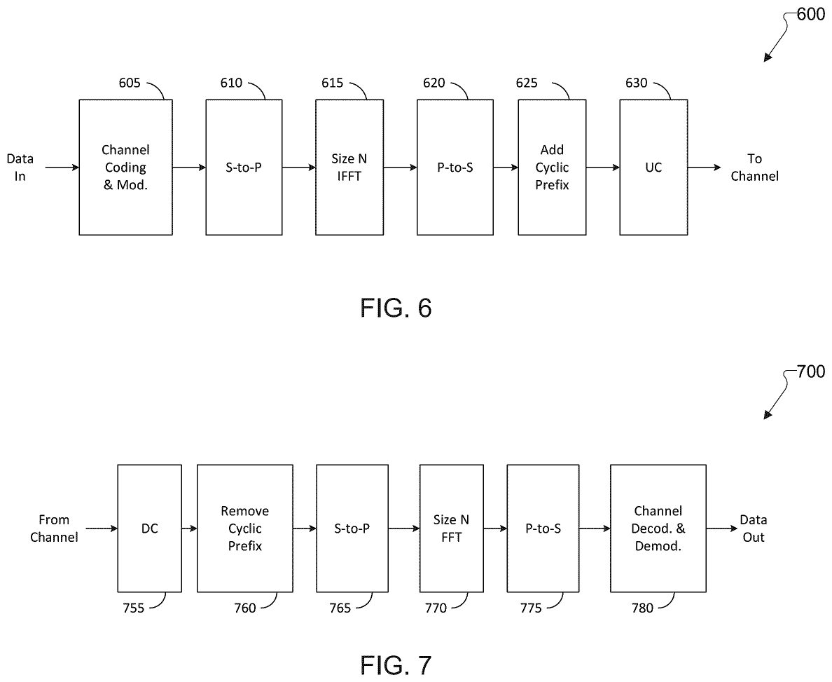

FIG. 6 and FIG. 7 illustrate example wireless transmit and receive paths according to this disclosure. In the following description, a transmit path 600 may be described as being implemented in an gNB (such as gNB 102), while a receive path 700 may be described as being implemented in a UE (such as UE 116). However, it will be understood that the receive path 700 can be implemented in an gNB and that the transmit path 600 can be implemented in a UE. In some embodiments, the receive path 700 is configured to support the codebook design and structure for systems having 2D antenna arrays as described in embodiments of the present disclosure.

The transmit path 600 includes a channel coding and modulation block 605, a serial-to-parallel (S-to-P) block 610, a size N inverse fast Fourier transform (IFFT) block 615, a parallel-to-serial (P-to-S) block 620, an add cyclic prefix block 625, and an up-converter (UC) 630. The receive path 700 includes a down-converter (DC) 755, a remove cyclic prefix block 760, a serial-to-parallel (S-to-P) block 765, a size N fast Fourier transform (FFT) block 770, a parallel-to-serial (P-to-S) block 775, and a channel decoding and demodulation block 780.

As illustrated in FIG. 600, the channel coding and modulation block 605 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols.

The serial-to-parallel block 610 converts (such as de-multiplexes) the serial modulated symbols to parallel data in order to generate N parallel symbol streams, where N is the IFFT/FFT size used in the gNB 102 and the UE 116. The size N IFFT block 615 performs an IFFT operation on the N parallel symbol streams to generate time-domain output signals. The parallel-to-serial block 620 converts (such as multiplexes) the parallel time-domain output symbols from the size N IFFT block 615 in order to generate a serial time-domain signal. The add cyclic prefix block 625 inserts a cyclic prefix to the time-domain signal. The up-converter 630 modulates (such as up-converts) the output of the add cyclic prefix block 625 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116.

As illustrated in FIG. 7, the down-converter 755 down-converts the received signal to a baseband frequency, and the remove cyclic prefix block 760 removes the cyclic prefix to generate a serial time-domain baseband signal. The serial-to-parallel block 765 converts the time-domain baseband signal to parallel time domain signals. The size N FFT block 770 performs an FFT algorithm to generate N parallel frequency-domain signals. The parallel-to-serial block 775 converts the parallel frequency-domain signals to a sequence of modulated data symbols. The channel decoding and demodulation block 780 demodulates and decodes the modulated symbols to recover the original input data stream.

Each of the gNBs 101-103 may implement a transmit path 600 as illustrated in FIG. 6 that is analogous to transmitting in the downlink to UEs 111-116 and may implement a receive path 700 as illustrated in FIG. 7 that is analogous to receiving in the uplink from UEs 111-116. Similarly, each of UEs 111-116 may implement the transmit path 600 for transmitting in the uplink to gNBs 101-103 and may implement the receive path 700 for receiving in the downlink from gNBs 101-103.

Each of the components in FIG. 6 and FIG. 7 can be implemented using only hardware or using a combination of hardware and software/firmware. As a particular example, at least some of the components in FIGS. 6 and FIG. 7 may be implemented in software, while other components may be implemented by configurable hardware or a mixture of software and configurable hardware. For instance, the FFT block 770 and the IFFT block 715 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as discrete Fourier transform (DFT) and inverse discrete Fourier transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIG. 6 and FIG. 7 illustrate examples of wireless transmit and receive paths, various changes may be made to FIG. 6 and FIG. 7. For example, various components in FIG. 6 and FIG. 7 can be combined, further subdivided, or omitted and additional components can be added according to particular needs. Also, FIG. 6 and FIG. 7 are meant to illustrate examples of the types of transmit and receive paths that can be used in a wireless network. Any other suitable architectures can be used to support wireless communications in a wireless network.

A CSI report from a UE can be periodic (P-CSI report) and multiplexed in a PUCCH transmission, semi-persistent (SP-CSI report) and multiplexed in a periodic PUCCH or PUSCH transmission that is configured by higher layers and activated by a DCI format, or aperiodic (A-CSI report) and multiplexed in a PUSCH transmission that is scheduled by a DCI format. A CSI report payload depends on a RI and/or a CRI because the RI value determines the PMI bit-width and the number of codewords (CWs) as, for example, PDSCH transmission with one CW can apply for RI≤4 and PDSCH transmission with two CWs can apply for RI>4.

A number of CQIs is determined from a number of CWs. For example, for one report per CQI reporting band (“wideband” or “sub-band”), there is one CQI per CW. Also, when the UE is configured with multiple non-zero-power (NZP) CSI-RS resources and to report CRI, a RI/PMI/CQI payload can depend on a value of CRI when a variable number of ports is associated with different CSI-RS resources. Therefore, a CSI report with two parts (Part 1 CSI and Part 2 CSI) needs to be used.

Part 1 CSI includes RI/CRI, CQI for the first CW and, for Type II CSI, additional information such as the number of non-zero amplitude coefficients for the two layers and has a predetermined payload. Part 2 CSI includes RI and CRI information and, in general, has a variable payload depending on the RI and CRI values. There are also conditions where the payload of the second part does not depend on the content of the first part. In such scenarios, the use of two-part UCI can be simplified.

A sub-band for CSI reporting is defined as a set of contiguous PRBs. The number of PRBs in a sub-band can be predetermined in a system operation as a function of a DL system bandwidth, provided by higher layers, or by a DCI format in a PDCCH. A number of PRBs in a sub-band can be included in a configuration for a CSI report. A “CSI reporting band” is defined as a set of either contiguous or non-contiguous sub-bands for a CSI report. For example, a CSI report band can include all the sub-bands within a DL system bandwidth (wideband CSI report). Alternatively, a CSI report band can include only a set of sub-bands within the DL system bandwidth and this is also referred to as partial band CSI report.

A UE can be configured for a CSI report for at least one CSI reporting band. The configuration can be by higher layers or by a DCI format in a PDCCH. When configured to report CSI over multiple CSI reporting bands, such as when operating at mmWave carrier frequencies, a UE can report CSI for any subset of the N CSI reporting bands. The number of CSI reporting bands in the subset can either be provided by higher layers or indicated by a DCI format in a PDCCH that triggers a CSI report. The UE may also recommend a value for the number of CSI reporting bands.

For a CSI report generation, a UE can be provided with multiple configurations for a CSI-ReportConfig IE, for example as described in NR specifications, where a configuration can include (a) a table for mapping CQI value to an MCS index value (or an SE value), (b) whether the CSI report includes a single (wideband) or multiple (sub-band) CQIs, (c) signals to measure and CQI quantities to report, (d) a periodicity and offset for the PUCCH transmission when the CSI report in multiplexed in a PUCCH, (e) a PUCCH resource for the PUCCH transmission, and so on.

A UE can be configured for communication with multiple service types requiring different respective reception reliabilities quantified by a block error rate (BLER) for a transport block (TB) reception. For example, a UE can simultaneously support mobile broadband (MBB) services such as a web browsing or a file download and ultra-reliable low latency services (URLLC) such as for augmented reality or virtual reality (AR/VR) where URLLC requires a TB BLER that is at least an order of magnitude smaller than for MBB. For example, depending on a signal-to-interference and noise ratio, or on a path-loss (PL), or on a reference signal received power (RSRP) that a UE experiences, a serving gNB can target a different BLER for a TB.

An A-CSI report can be triggered by a DCI format and the UE multiplexes the A-CSI report in an associated PUSCH transmission, that can be with or without a TB, or in an associated PUCCH transmission. One value/state of the field indicates no A-CSI report to be multiplexed in the PUSCH transmission. Other values of the field are configured by higher layers to map to one or more of configuration of a CSI-ReportConfig information element (IE), for example as described in NR specifications, that determine the contents of the A-CSI report.

It is also beneficial to trigger A-CSI reports by a DCI format scheduling a PDSCH reception as a CSI report is typically associated with PDSCH receptions and a UE may not be monitoring PDCCH for a DCI format scheduling a PUSCH transmission. This can be the case when a search space set for PDCCH receptions that provide a DCI format scheduling a PUSCH transmission and capable of triggering an A-CSI report is separate from a search space set for PDCCH receptions that provide a DCI format scheduling a PDSCH reception.

Including an A-CSI report trigger in a DCI format scheduling a PDSCH reception by a UE can provide the intended functionality for triggering and multiplexing of an A-CSI report in a PUCCH transmission where the UE also reports HARQ-ACK information in response to a decoding outcome of a TB in the PDSCH. However, such mechanism is prone to the error case when the UE fails to detect the DCI format scheduling the PDSCH reception and triggering the A-CSI report that causes a different understanding between the gNB and the UE for a total UCI payload and possibly of a resource that the UE uses for the PUCCH transmission.

For a UE supporting multiple service types, CSI reports, and generally UCI, associated with different services can have different priority of importance that reflects the relative importance of a respective service. For CSI reports multiplexed in PUCCH transmissions, a periodicity of respective PDCCH transmissions can be different and it is then possible that the UE needs to simultaneously transmit more than one PUCCH with CSI reports of different priorities.

Multiplexing of CSI reports in a single PUCCH transmission may not be practically feasible when the CSI reports have different reception reliability requirements reflecting the different reception reliability requirements of the respective different services. Also, the UE may need to simultaneously transmit a first PUCCH with HARQ-ACK information or with SR associated with a first service type of a first priority and a second PUCCH with one or more CSI reports that are associated with a second service type of a second priority.

Therefore, there is a need to enable a UE to provide separate CSI reports, for example associated with different BLER targets, for a TB decoding in a PDSCH reception. There is another need to enable a UE to provide multiple CSI reports associated, for example with respective multiple BLER targets, for TB decodings in PDSCH receptions. There is another need to enable triggering of an A-CSI report using a DCI format that schedules a PDSCH reception by a UE when it does not trigger an A-CSI report by the UE. Finally, there is another need to provide mechanisms for a UE to transmit PUCCH when a UE would simultaneously transmit more than one PUCCH when respective UCI types have different transmission priorities.

Various embodiments of the present disclosure enable a UE to provide separate CSI reports associated with different targets for a BLER of a TB decoding in a PDSCH reception. Various embodiments of the present disclosure also enable a UE to provide multiple CSI reports associated with respective multiple targets for BLERs of TB decodings in PDSCH receptions. Various embodiments of the present disclosure additionally enable triggering of an A-CSI report using a DCI format that schedules a PDSCH reception by a UE when it does not trigger an A-CSI report by the UE. Various embodiments of the present disclosure further provide mechanisms for a UE to transmit PUCCH when a UE would simultaneously transmit more than one PUCCH when respective UCI types have different transmission priorities.

In one embodiment, configurations to a UE are provided in order for the UE to provide multiple CQI reports, in a same CSI report or in respective multiple CSI reports. For example, the multiple CQI reports can be associated with respective multiple target BLERs for decodings of TBs in PDSCH receptions. In one embodiment, enhancements are provided to a CSI-ReportConfig IE in order for a gNB to configure a UE to provide multiple CQI reports for a single CSI report corresponding to a BWP of a cell.

A UE can be configured to provide a set of CQI reports, for example for a corresponding set of BLERs, for TB decodings in PDSCH receptions. A CQI report value maps to an MCS index value, or equivalently to a spectral efficiency (SE) value, for modulation and coding scheme of a TB in a PDSCH. A respective mapping table is referred to as cqi-Table in this disclosure. Each cqi-Table can also be associated with a BLER where the association can be defined in the system operation or be provided to the UE by higher layers as is subsequently described. For example, Table 1 and Table 2 are a first cqi-Table and a second cqi-Table mapping MCS index values of a CQI report to a modulation order and a code rate.

TABLE 1
MCS index table 1

| MCS Index | Modulation | Target code | Spectral |
|---|---|---|---|
| I_{MCS} | Order Qₘ | Rate R × [1024] | efficiency |
| 0 | 2 | 120 | 0.2344 |
| 1 | 2 | 157 | 0.3066 |
| 2 | 2 | 193 | 0.3770 |
| 3 | 2 | 251 | 0.4902 |
| 4 | 2 | 308 | 0.6016 |
| 5 | 2 | 379 | 0.7402 |
| 6 | 2 | 449 | 0.8770 |
| 7 | 2 | 526 | 1.0273 |
| 8 | 2 | 602 | 1.1758 |
| 9 | 2 | 679 | 1.3262 |
| 10 | 4 | 340 | 1.3281 |
| 11 | 4 | 378 | 1.4766 |
| 12 | 4 | 434 | 1.6953 |
| 13 | 4 | 490 | 1.9141 |
| 14 | 4 | 553 | 2.1602 |
| 15 | 4 | 616 | 2.4063 |
| 16 | 4 | 658 | 2.5703 |
| 17 | 6 | 438 | 2.5664 |
| 18 | 6 | 466 | 2.7305 |
| 19 | 6 | 517 | 3.0293 |
| 20 | 6 | 567 | 3.3223 |
| 21 | 6 | 616 | 3.6094 |
| 22 | 6 | 666 | 3.9023 |
| 23 | 6 | 719 | 4.2129 |
| 24 | 6 | 772 | 4.5234 |
| 25 | 6 | 822 | 4.8164 |
| 26 | 6 | 873 | 5.1152 |
| 27 | 6 | 910 | 5.3320 |
| 28 | 6 | 948 | 5.5547 |

| | | |
|---|---|---|
| 29 | 2 | reserved |
| 30 | 4 | reserved |
| 31 | 6 | reserved |

TABLE 2
MCS index table 2

| MCS Index | Modulation | Target code | Spectral |
|---|---|---|---|
| I_{MCS} | Order Qₘ | Rate R × [1024] | efficiency |
| 0 | 2 | 30 | 0.0586 |
| 1 | 2 | 40 | 0.0781 |
| 2 | 2 | 50 | 0.0977 |
| 3 | 2 | 64 | 0.1250 |
| 4 | 2 | 78 | 0.1523 |
| 5 | 2 | 99 | 0.1934 |
| 6 | 2 | 120 | 0.2344 |
| 7 | 2 | 157 | 0.3066 |
| 8 | 2 | 193 | 0.3770 |
| 9 | 2 | 251 | 0.4902 |
| 10 | 2 | 308 | 0.6016 |
| 11 | 2 | 379 | 0.7402 |
| 12 | 2 | 449 | 0.8770 |
| 13 | 2 | 526 | 1.0273 |
| 14 | 2 | 602 | 1.1758 |
| 15 | 4 | 340 | 1.3281 |
| 16 | 4 | 378 | 1.4766 |
| 17 | 4 | 434 | 1.6953 |
| 18 | 4 | 490 | 1.9141 |
| 19 | 4 | 553 | 2.1602 |
| 20 | 4 | 616 | 2.4063 |
| 21 | 6 | 438 | 2.5664 |
| 22 | 6 | 466 | 2.7305 |
| 23 | 6 | 517 | 3.0293 |
| 24 | 6 | 567 | 3.3223 |
| 25 | 6 | 616 | 3.6094 |
| 26 | 6 | 666 | 3.9023 |
| 27 | 6 | 719 | 4.2129 |
| 28 | 6 | 772 | 4.5234 |

| | | |
|---|---|---|
| 29 | 2 | reserved |
| 30 | 4 | reserved |
| 31 | 6 | reserved |

In one example, a UE can be configured by an enhanced CSI-ReportConfig IE to provide a CQI report indicating a first MCS index value in a cqi-Table and a second CQI report indicating a second MCS index value in the cqi-Table. The second CQI report can indicate an entry in the cqi-Table, or can be differential to the first CQI report by providing an offset relative to the first CQI report (subject to the minimum and maximum values). Also, a first BLER associated with the first MCS index value can be specified in the system operation while a second BLER associated with the second MCS index value can be provided by the enhanced CSI-ReportConfig IE or can be indicated by the UE as part of the CSI report. For example, the first MCS index value can be associated with a first BLER, such as 0.1, and the second MCS index value can be associated with a second BLER, such as 0.001, for a TB decoding in a PDSCH reception.

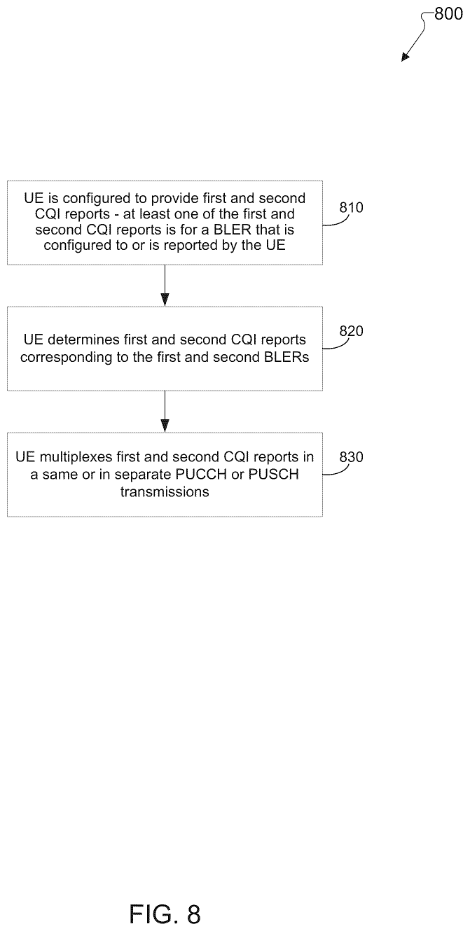

FIG. 8 illustrates a flow chart of UE procedure 800 to provide a first CQI report and a second CQI report according to embodiments of the present disclosure. An embodiment of the UE procedure 800 shown in FIG. 8 is for illustration only. One or more of the components illustrated in FIG. 8 can be implemented in specialized circuitry configured to perform the noted functions or one or more of the components can be implemented by one or more processors executing instructions to perform the noted functions. Other embodiments are used without departing from the scope of the present disclosure.

As illustrated in FIG. 8, a UE is configured by higher layers to provide a first CQI report and a second CQI report in a CSI report wherein, for example, the first CQI report corresponds to a first BLER for a TB decoding and the second CQI report corresponds to a second BLER for a TB decoding. At least one of the first and second BLERs can be configured by higher layers to the UE or is reported by the UE in the CSI report in step 810. When the UE is not configured a BLER for a CQI report or does not report a BLER in the CSI report, the BLER can be specified in the system operation.

The UE determines a first CQI report corresponding to the first BLER and a second CQI report corresponding to the second BLER in step 820. The UE multiplexes the first CQI report and the second CQI report in a same or in separate PUCCH or PUSCH transmissions in step 830.

In one example, a UE can be configured by an enhanced CSI-ReportConfig IE to provide a first CQI report indicating a first MCS index value in a first cqi-Table, and a second CQI report indicating a second MCS index value in a second cqi-Table. For example, the first and second cqi-Tables can be associated with respective first and second BLERs. Either or both of the first and second cqi-Tables can be defined in a system operation or be provided by the enhanced CSI-ReportConfig IE.

When a UE is configured to provide multiple CQI reports in a same CSI report, Part 1 CSI includes RI/CRI and the multiple CQI reports. By specification in the system operation or by configuration through higher layers, the UE can provide a RI/CRI report for each CQI report or provide a common RI/CRI report for each CQI report from the multiple CQI reports. In case of a RI/CRI report for each CQI report, a different PDSCH transmission rank can be enabled for each BLER and a separate Part 2 CSI can also be provided in the CSI report. In case of a common RI/CRI report for the multiple CQI reports, a CSI report is same as when the UE provides a single CQI report with the only exception that the UE actually provides multiple CQI reports.

The multiple CQI reports can be separate (individual) CQI reports or, with the exception of one CQI report that serves as a reference, the multiple CQI reports can be differential values to the reference CQI report. For example, the reference CQI report can be the one for the smallest BLER, or for the largest BLER from the set of BLERs, or for a reference UE receiver configuration such as the one corresponding to a maximum number of UE receiver antenna ports. When the UE includes multiple CQI reports in a CSI report, the CSI report is same as when the UE includes only one CQI report, but the UE is provided multiple respective configurations for the multiple CQI reports. For example, a configuration for a CQI report can include an associated BLER value or an associated cqi-Table. Providing multiple CQI reports in a same CSI report can be advantageous over separately providing a first CSI report with the first CQI in a first PUCCH transmission and a second CSI report that includes only the second CQI (no RI/CRI or PMI) in a second PUCCH transmission as it can provide coding gains due to a larger total payload, particularly for the second CQI, and reduce PUCCH overhead.

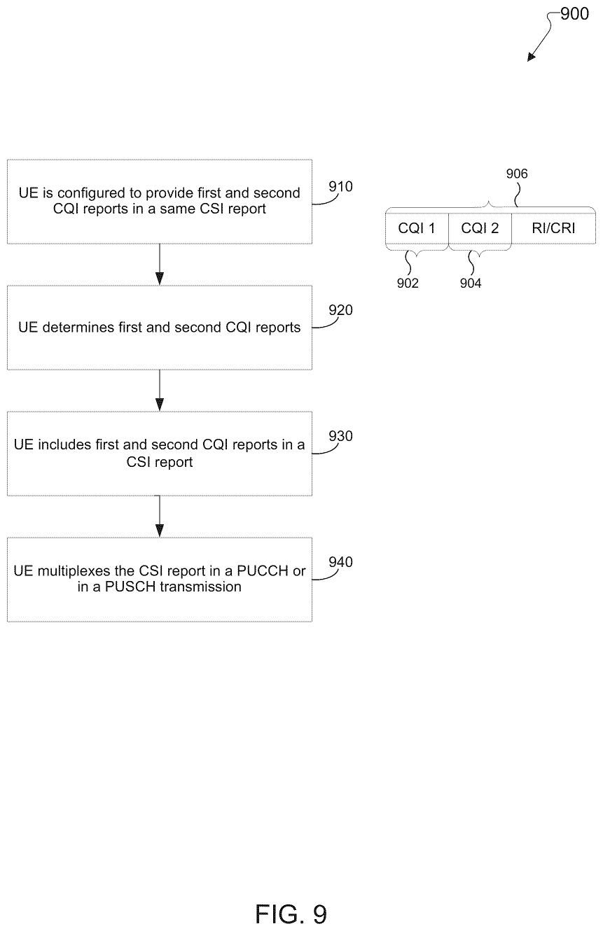

FIG. 9 illustrates a flow chart of UE procedure 900 to provide a first CQI report and a second CQI report in a same CSI report according to embodiments of the present disclosure. An embodiment of the UE procedure 900 shown in FIG. 9 is for illustration only. One or more of the components illustrated in FIG. 9 can be implemented in specialized circuitry configured to perform the noted functions or one or more of the components can be implemented by one or more processors executing instructions to perform the noted functions. Other embodiments are used without departing from the scope of the present disclosure.

As illustrated in FIG. 9, a UE is configured by higher layers to provide a first CQI report 902 and a second CQI report 904 in a same CSI report, such as a Part 1 CSI 906 of a CSI report in step 910. For example, the first and second CQI reports can correspond to first and second BLERs, or to first and second UE receiver antennas or gNB transmitter antennas configurations, or to first cqi-Table and second cqi-Table. The UE determines the first CQI report and the second CQI report in step 920. The UE includes the first CQI report and the second CQI report in a CSI report in step 930. The CSI report may also include a RI/CRI indication for a Part 1 CSI and additional information for a Part 2 CSI. The UE multiplexes the CSI report in a PUCCH or in a PUSCH transmission in step 940.

When a UE is configured to provide multiple CSI reports in respective multiple PUCCH transmissions, the UE may need to transmit in time-overlapping PUCCH resources more than one PUCCH that provides respective more than one CSI report. The UE can be configured to either multiplex the more than one CSI report in a single PUCCH transmission or to drop some of the more than one PUCCH transmission and multiplex the CSI reports from the remaining PUCCHs in a single PUCCH transmission. For example, the UE can drop all time-overlapping PUCCH transmissions except one. When the UE is configured to multiplex the CSI reports in a single PUCCH transmission, the UE can also be configured separate PUCCH resources for determining a PUCCH resource for the single PUCCH transmission.

The UE can determine the CSI report(s) to transmit in a single PUCCH based on a transmission priority that can also be part of the configuration for an enhanced CSI-ReportConfig IE. In the following, a priority order is assumed to be in a descending order of an index, but the same principles apply if a priority order is in an ascending order of an index. For example, if a priority order is in a descending order of an index, a first CSI report can be configured with a transmission priority 0 and a second CSI report can be configured with a transmission priority 1 by a corresponding value of a priority parameter in the corresponding CSI-ReportConfig IE and, when the UE determines that corresponding PUCCH transmissions would overlap in time, the UE transmits only the PUCCH with the CSI report associated with the smaller transmission priority 0.

For example, a first CSI report configuration can have a transmission priority 0 and a second CSI report configuration can have a transmission priority 1 and, when corresponding PUCCH transmissions would overlap in time, the UE can be configured to either multiplex the CSI reports in a single PUCCH transmission or to transmit the CSI report associated with a smaller value (corresponding to larger priority) for a parameter priority that is provided by the CSI-ReportConfig IE. Instead of not multiplexing CSI reports with different transmission priorities being a default UE behavior, whether or not the UE performs such multiplexing can depend on a corresponding configuration to the UE by higher layers where the UE can be configured whether or not to multiple CSI reports with different sets of transmission priority values. When the UE is not provided the configuration, the default behavior for the UE can be to not multiplex CSI reports associated with different transmission priorities in a PUCCH transmission.

Similar, if a UE would transmit a PUCCH with HARQ-ACK information having a first priority and a PUCCH with a CSI report having a second priority and the UE determines that the two PUCCH transmissions would overlap in time, the UE can transmit the PUCCH with the UCI (HARQ-ACK information or CSI report) having the larger priority and multiplex in a same PUCCH the HARQ-ACK information and the CSI report when they have a same priority. Instead of not multiplexing HARQ-ACK information and a CSI report with different priorities being a default UE behavior, whether or not the UE performs such multiplexing can depend on a corresponding configuration to the UE by higher layers indicating that multiplexing of HARQ-ACK information and CSI report with different priorities in a PUCCH transmission is enabled. The configuration can be same or separate than the configuration for multiplexing CSI reports of different priorities in a same PUCCH.

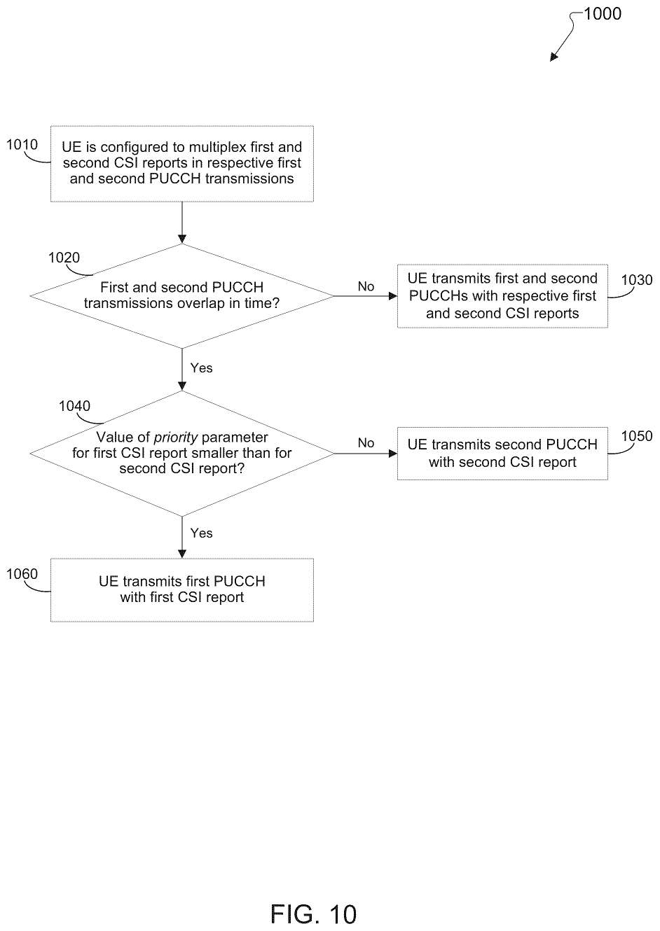

FIG. 10 illustrates a flow chart of UE procedure 1000 to determine a CSI report to transmit in a PUCCH, when the UE is configured to transmit multiple CSI reports in respective multiple PUCCHs in resources that overlap in time, according to embodiments of the present disclosure. An embodiment of the UE procedure 1000 shown in FIG. 10 is for illustration only. One or more of the components illustrated in FIG. 10 can be implemented in specialized circuitry configured to perform the noted functions or one or more of the components can be implemented by one or more processors executing instructions to perform the noted functions. Other embodiments are used without departing from the scope of the present disclosure.

A UE is configured by higher layers to multiplex a first CSI report in a first PUCCH transmission and a second CSI report in a second PUCCH transmission in step 1010. The first and second CQI reports include respective first and second CQI reports that can be associated with different cqi-Tables. The UE determines whether the first PUCCH transmission and the second PUCCH transmission would overlap in time in step 1020. When the first and second PUCCH transmissions would not overlap in time, the UE transmits the first PUCCH with the first CSI report and the second PUCCH with the second CSI report in step 1030. When the first and second PUCCH transmissions would overlap in time, the UE determines a value of a priority parameter that is included in the IE that configures the transmission of each CSI report in a PUCCH in step 1040, such as a CSI-ReportConfig IE, and transmits the first PUCCH with the first CSI report when a corresponding priority value is smaller in step 1050, and transmits the second PUCCH with the second CSI report when a corresponding priority value is smaller in step 1060.

For demodulation of data symbols and decoding of a TB in a PDSCH reception, a UE needs to know an MCS table corresponding to an MCS field value in a DCI format scheduling the PDSCH reception in order to determine an appropriate entry indicating a modulation order and a code rate. A determination of the MCS table can be enabled by several means. For example, for DCI formats scheduling a PDSCH reception, a first DCI format can be associated with a first MCS table and a second DCI format can be associated with a second MCS table. The first DCI format can also be associated with a first priority and the second DCI format can be associated with a second priority. For example, for a DCI format scheduling a PDSCH reception, a first value of a priority indicator field in the DCI format can be associated with a first MCS table and a second value of the priority indicator field in the DCI format can be associated with a second MCS table.

The UE determining a priority for HARQ-ACK information that the UE generates in response to a TB provided in a PDSCH reception (or a priority for a PUCCH with the HARQ-ACK information) by the value of the priority indicator field.

A same approach can apply for a DCI format scheduling a PUSCH transmission. For example, for DCI formats scheduling a PUSCH transmission, different DCI formats or different values of a priority indicator field in a DCI format can be used to determine an MCS table for mapping a value of an MCS field in the DCI format and for determining a priority for a TB of an UL-SCH in the PUSCH transmission (or for determining a priority of the PUSCH transmission).

An association of values for the priority indicator field in the DCI format to MCS tables can be provided by higher layers or can be predetermined in the system operation. For example, higher layer signaling from a gNB can indicate to a UE that a first value of the priority indicator field is associated with a first MCS table specified in the system operation and a second value of the priority indicator field is associated with a third MCS table specified in the system operation. For example, the UE can be provided by higher layers an association of the priority indicator field value of 0 to the first MCS table and an association of the priority indicator field value of 1 to the third MCS table. In general, the UE can be provided by higher layers an association of the priority indicator field value of 0 to a first MCS table from a predetermined or configured set of MCS tables and an association of the priority indicator field value of 1 to a second MCS table from the predetermined or configured set of MCS tables. Alternatively, instead of being configured by higher layers, the mapping among values of the priority indicator field and MCS tables can be predetermined in the system operation. Instead of associating a value of a priority indicator field in a DCI format with an MCS table (cqi-Table), it is also possible to introduce a separate field in the DCI format, wherein the field indicates an MCS table (cqi-Table) from a set of configured or predetermined MCS tables.

In one embodiment, enabling A-CSI report triggering by a DCI format associated with scheduling of PDSCH receptions is considered.

A UE can be configured separate search space sets for monitoring PDCCHs with a DCI format scheduling a PDSCH reception by the UE and for monitoring PDCCHs with a DCI format scheduling a PUSCH transmission from the UE. For example, when a UE has DL dominant traffic and sparse UL traffic, such as for file downloads or web browsing, a search space set for a first DCI format scheduling a PDSCH reception can have a smaller periodicity than a search space set for a second DCI format scheduling a PUSCH transmission. It is then beneficial to trigger A-CSI reports by the first DCI format in order to avoid a larger latency that would be required by using the second DCI format.

A first DCI format scheduling a PDSCH reception by a UE can include an A-CSI trigger field. The A-CSI trigger field can be same or different as an A-CSI trigger field in a second DCI format scheduling a PUSCH transmission from the UE. When the A-CSI trigger field is same in both first and second DCI formats, the UE can be provided a single configuration for the mapping of the states of the A-CSI trigger field to the contents of an A-CSI report. When the A-CSI trigger fields are different in the first and second DCI formats, either in size or in the mappings of the states, the UE can be provided separate configurations for the mappings of the states of the A-CSI trigger field to the contents of an A-CSI report for the first and second DCI formats.

When a A-CSI trigger field in a DCI format that is used for scheduling a PDSCH reception triggers an A-CSI report by a UE, the contents/bits of the DCI format, other than the one for the A-CSI trigger field, can be reinterpreted to schedule a PUSCH or a PUCCH transmission instead of a PDSCH reception.

In one example, whether the DCI format schedules a PUSCH transmission or a PUCCH transmission can be configured to the UE by higher layers. In another example, whether the DCI format schedules a PUSCH transmission or a PUCCH transmission can be indicated to the UE by the re-interpreted contents of the DCI format. For A-CSI report multiplexing in a PUCCH transmission, the UE can be provided by higher layers a separate configuration of resources than for a PUCCH transmission with HARQ-ACK information.

When the DCI format schedules a PUSCH transmission with an A-CSI report the reinterpretation of the bits (other than the for the ones of the A-CSI report trigger) of the DCI format can provide one or more of the following information fields: whether DCI format scheduled a PUSCH transmission or a PUCCH transmission, for example using 1 bit (when this information is provided by the DCI format); a carrier indicator; a BWP indicator; frequency domain resource allocation for the PUSCH transmission; time domain resource allocation for the PUSCH transmission; a frequency hopping flag; MCS for the A-CSI report modulation and coding scheme; a transmit power control (TPC) command; an SRS resource indicator; an SRS request; a supplementary UL (SUL) carrier indicator for whether the PUSCH transmission is on an UL or on an SUL carrier; and/or reserved bits or additional fields.

When the DCI format schedules a PUCCH transmission with an A-CSI report the reinterpretation of the bits (other than the for the ones of the A-CSI report trigger) of the DCI format can provide one or more of the following information fields: a PUCCH resource indicator providing a PUCCH resource; a PDCCH-to-CSI report timing indicator providing a slot for the PUCCH transmission relative to the slot of the PDCCH reception with the DCI format; and/or a TPC command for PUCCH transmission.

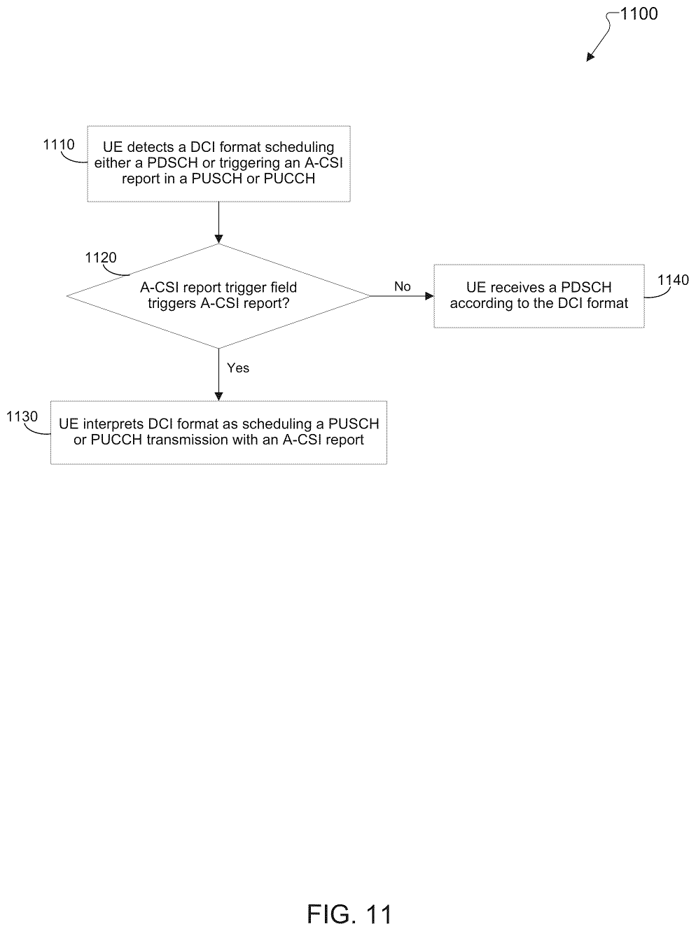

FIG. 11 illustrates a flow chart of UE procedure 1100 to determine an A-CSI report triggering in a PUSCH transmission on in a PUCCH transmission based on a detection of a DCI format that is also used to schedule a PDSCH reception, according to embodiments of the present disclosure. An embodiment of the UE procedure 1100 shown in FIG. 11 is for illustration only. One or more of the components illustrated in FIG. 11 can be implemented in specialized circuitry configured to perform the noted functions or one or more of the components can be implemented by one or more processors executing instructions to perform the noted functions. Other embodiments are used without departing from the scope of the present disclosure.

A UE detects a DCI format that can be used to schedule either a PDSCH reception or a multiplexing of an A-CSI report in a PUSCH or PUCCH transmission in step 1110. The UE determines whether an A-CSI report trigger field in the DCI format triggers a multiplexing of an A-CSI report in a PUSCH or PUCCH transmission in step 1120. When the A-CSI report trigger field triggers a multiplexing of an A-CSI report in a PUSCH or PUCCH transmission, the UE reinterprets the information in the DCI format as scheduling a PUSCH or PUCCH transmission with an A-CSI report as indicated by a value of the A-CSI report trigger field in step 1130. When the A-CSI report trigger field does not trigger a multiplexing of an A-CSI report in a PUSCH or PUCCH transmission, the UE receives a PDSCH according to the DCI format in step 1140.

In one embodiment, a determination of PUSCH or PUCCH channel transmissions is considered, including power allocation to the transmissions, based on respective priorities.

A UE can determine a prioritization for power allocation to a channel or signal transmission based on a respective transmission priority when a total transmission power would otherwise exceed a maximum transmission power P_{CMAX}(i) in transmission occasion i. For example, when a UE would transmit a first PUCCH with a first CSI report on a first cell such as a primary cell (PCell) and a second PUCCH with a second CSI report on a second cell such as primary secondary cell (PSCell) and a priority value for the second CSI report is smaller than a priority value for the first CSI report, the UE prioritizes power allocation to the second PUCCH transmission on the PSCell.

The same principle can be extended to transmission of other information that can be associated with a priority value such as a scheduling request (SR), a HARQ-ACK information in response to SPS PDSCH receptions, a periodic PUSCH transmission, and so on. For example, a UE prioritizes power allocation to a first PUCCH transmission with HARQ-ACK information or SR over a second PUCCH transmission with HARQ-ACK information or SR when the first PUCCH transmission associated with a configuration for HARQ-ACK information or SR having a priority value that is smaller than a priority value associated with a configuration for HARQ-ACK information or SR associated with the second PUCCH transmission when the first and second PUCCH transmissions overlap in time and a total transmission power would otherwise (without the prioritization) exceed P_{CMAX}(i) for a transmission occasion i.

A transmission priority for data information or UCI can also be used by a UE to determine a multiplexing of UCI in a PUSCH transmission. For example, based on an indication by a DCI format scheduling a PUSCH transmission or based on an indication from a configuration of a PUSCH transmission by higher layers, the UE can determine a transmission priority for the PUSCH transmission. For example, when a PUSCH transmission is scheduled by a DCI format, a UE can determine a priority for the PUSCH transmission based on the DCI format size, or based on an RNTI scrambling the CRC of the DCI format, or based on an explicit indication by a priority indicator field in the DCI format. Based on an indication by a DCI format scheduling a PDSCH reception and triggering multiplexing of associated HARQ-ACK information in a PUCCH transmission, or based on an indication from a configuration of a PUCCH transmission by higher layers, the UE can determine a corresponding priority for the PUCCH transmission (or for the UCI multiplexed in the PUCCH transmission).

When a PUSCH transmission and a PUCCH transmission overlap in time and a UE is not capable or is not configured for simultaneous PUSCH and PUCCH transmissions, the UE can determine to multiplex the UCI in the PUSCH and transmit the PUSCH when the UCI/PUCCH and the UL-SCH/PUSCH are associated with a same priority or to transmit only the PUSCH without multiplexing the UCI and to not transmit the PUCCH when the PUSCH is associated with a smaller value (larger priority) of a priority parameter than the PUCCH, or to transmit only the PUCCH and not transmit the PUSCH when the PUCCH is associated with a smaller value (larger priority) of a priority parameter than PUSCH. When the UE would transmit multiple PUSCHs, for example when the UE operates with UL carrier aggregation, and the PUCCH is associated with a smaller value (larger priority) of a priority parameter than all multiple PUSCHs, the UE does not transmit the multiple PUSCHs. When a PUSCH transmission and a PUCCH transmission overlap in time and a UE is capable and configured for simultaneous PUSCH and PUCCH transmissions, the UE transmits the PUSCH and the PUCCH.

Similar to multiplexing UCI types with different priorities in a PUCCH, whether or not the UE multiplexes UCI and TB/UL-SCH of different priorities in a PUSCH can be enabled by higher layer signaling from a serving gNB. The configuration can be per UCI type and be provided separately for multiplexing HARQ-ACK information and for multiplexing a CSI report. A motivation is that different UCI types can be of different importance and have different payloads or reception reliability requirements. For example, the UE can be indicated to multiplex HARQ-ACK information and not indicated to multiplex a CSI report of a different priority than the priority of the TB/UL-SCH in the PUSCH.

The configuration can also be per priority value and can be separate per priority value. For example, a motivation is that multiplexing of HARQ-ACK information of larger priority in a PUSCH with TB/UL-SCH of lower priority is desirable as the importance of the HARQ-ACK information is large and the payload is typically small, a potential negative impact on the TB/UL-SCH of lower priority can be tolerated, while the reverse may not apply (in which case, in case of overlapping, the UE drops the PUCCH transmission with the HARQ-ACK information of lower priority and transmits the PUSCH with the TB/UL-SCH of larger priority). For example, the UE can be indicated to multiplex HARQ-ACK information of larger priority in a PUSCH with a TB/UL-SCH of smaller priority and not be indicated to multiplex HARQ-ACK information of smaller priority in a PUSCH with a TB/UL-SCH of larger priority. The configuration can also be separate for a PUSCH transmission that is scheduled by a DCI format and for a PUSCH transmission that is configured by higher layers. A same procedure can apply for multiplexing UCI types of different priorities in a same PUCCH. For example, the UE can be provided a first indication to multiplex HARQ-ACK information of smaller priority with a CSI report of larger priority in a PUCCH and not provided a second indication to multiplex HARQ-ACK information of larger priority with a CSI report of smaller priority in a PUCCH (in which case, in case of overlapping, the UE drops the PUCCH with the CSI report of smaller priority and transmits the PUCCH with the HARQ-ACK information of larger priority).

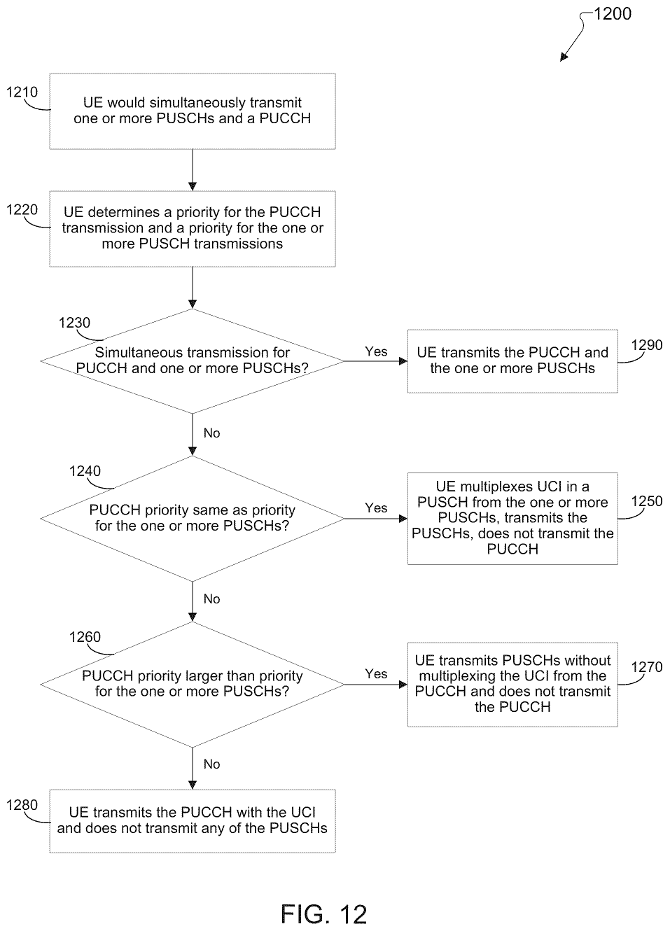

FIG. 12 illustrates a flow chart of UE procedure 1200 to determine whether to multiplex UCI in a PUSCH or in a PUCCH when the UE would simultaneously transmit the PUSCH and the PUCCH according to embodiments of the present disclosure. An embodiment of the UE procedure 1200 shown in FIG. 12 is for illustration only. One or more of the components illustrated in FIG. 12 can be implemented in specialized circuitry configured to perform the noted functions or one or more of the components can be implemented by one or more processors executing instructions to perform the noted functions. Other embodiments are used without departing from the scope of the present disclosure.

As illustrated in FIG. 12, a UE would simultaneously transmit one or more PUSCHs and a PUCCH in step 1210. The UE determines a priority for the PUCCH transmission (or for the UCI in the PUCCH transmission) and a priority for the one or more PUSCH transmissions (or for the data or UCI in the PUSCH transmission) that have a same priority in step 1220. The UE determines whether the UE can simultaneously transmit the PUCCH and the one or more PUSCHs in step 1230. When the UE cannot simultaneously transmit the PUCCH and the one or more PUSCHs, the UE determines whether or not the PUCCH priority is same as the priority for the one or more PUSCHs in step 1240.

When the PUCCH priority is same as the priority for the one or more PUSCHs, the UE multiplexes the UCI in a PUSCH from the one or more PUSCHs, transmits the one or more PUSCHs, and does not transmit the PUCCH in step 1250. When the PUCCH priority is not same as the priority for the one or more PUSCHs, the UE determines whether or not the PUCCH priority is larger than the priority for the one or more PUSCHs in step 1260. When the PUCCH priority is larger than the priority for the one or more PUSCHs, the UE transmits the one or more PUSCHs without multiplexing the UCI from the PUCCH and does not transmit the PUCCH in step 1270. When the PUCCH priority is smaller than the priority for the one or more PUSCHs, the UE transmits the PUCCH with the UCI and does not transmit any of the one or more PUSCHs in step 1280. When the UE can simultaneously transmit the PUCCH and the one or more PUSCHs, the UE transmits the PUCCH and the one or more PUSCHs in step 1290.

Although the present disclosure has been described with an exemplary embodiment, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A method for a user equipment (UE) to provide first uplink control information (UCI), the method comprising:
determining a first priority for a first physical uplink control channel (PUCCH) and a second priority for a first physical uplink shared channel (PUSCH), wherein:
the first priority is different than the second priority, and
the first PUCCH includes the first UCI,
determining that a transmission of the first PUCCH would overlap in time with a transmission of the first PUSCH;
transmitting the first PUSCH when the second priority is larger than the first priority, wherein:
the first PUSCH includes the first UCI when the first UCI is first acknowledgement information, and
the first PUSCH does not include the first UCI when the first UCI is first channel state information; and
transmitting the first PUCCH when the first priority is larger than the second priority.

2. The method of claim 1, further comprising:
determining the first priority for a second PUCCH and the second priority for a third PUCCH;
determining that a transmission of the second PUCCH would overlap in time with a transmission of the third PUCCH; and
determining to transmit the first PUCCH after resolving the time overlap of the second PUCCH and the third PUCCH, wherein:
the second PUCCH includes second acknowledgement information,
the third PUCCH includes third acknowledgement information and second channel state information,
the first PUCCH includes only the second acknowledgement information and the third acknowledgement information, and
the first priority is larger than the second priority.

3. The method of claim 1, further comprising receiving an indication to include a UCI in a PUSCH when a priority associated with the UCI is different than a priority associated with the PUSCH.

4. The method of claim 1, further comprising:
determining the second priority for a second PUSCH;
determining that the transmission of the first PUCCH would overlap in time with a transmission of the second PUSCH; and
transmitting the first PUCCH, wherein:
the first PUSCH is on a first cell,
the second PUSCH is on a second cell that is different from the first cell,
the first PUCCH is on a third cell, and
the first priority is larger than the second priority.

5. The method of claim 1, wherein:
the transmission of the first PUSCH is scheduled by a downlink control information (DCI) format, and
the DCI format indicates the second priority.

6. The method of claim 1, wherein:
the transmission of the first PUSCH is configured by higher layer signaling, and
the higher layer signaling indicates the second priority.

7. The method of claim 1, further comprising:
transmitting a second PUSCH, wherein the second PUSCH has the first priority;
transmitting a third PUSCH, wherein the third PUSCH has the second priority; and
prioritizing power allocation to the third PUSCH over the second PUSCH, wherein the second priority is larger than the first priority.

8. A user equipment (UE) comprising:
a processor configured to determine:
a first priority for a first physical uplink control channel (PUCCH) and a second priority for a first physical uplink shared channel (PUSCH), wherein:
the first priority is different than the second priority, and
the first PUCCH includes a first uplink control information (UCI), and
that a transmission of the first PUCCH would overlap in time with a transmission of the first PUSCH; and
a transceiver operably coupled to the processor, the transceiver configured to transmit:
the first PUSCH when the second priority is larger than the first priority, wherein:
the first PUSCH includes the first UCI when the first UCI is first acknowledgement information, and
the first PUSCH does not include the first UCI when the first UCI is first channel state information, and
the first PUCCH when the first priority is larger than the second priority.

9. The UE of claim 8, wherein:
the processor is further configured to determine:
the first priority for a second PUCCH and the second priority for a third PUCCH.
that a transmission of the second PUCCH would overlap in time with a transmission of the third PUCCH, and
to transmit the first PUCCH after resolving the time overlap of the second PUCCH and the third PUCCH, wherein:
the second PUCCH includes second acknowledgement information,
the third PUCCH includes third acknowledgement information and second channel state information,
the first PUCCH includes only the second acknowledgement information and the third acknowledgement information, and
the first priority is larger than the second priority.

10. The UE of claim 8, wherein the transceiver is further configured to receive an indication to include a UCI in a PUSCH when a priority associated with the UCI is different than a priority associated with the PUSCH.

11. The UE of claim 8, wherein:
the processor is further configured to determine:
the second priority for a second PUSCH, and
that the transmission of the first PUCCH would overlap in time with a transmission of the second PUSCH; and
the transceiver is further configured to transmit the first PUCCH, wherein:
the first PUSCH is on a first cell,
the second PUSCH is on a second cell that is different from the first cell,
the first PUCCH is on a third cell, and
the first priority is larger than the second priority.

12. The UE of claim 8, wherein:
the transmission of the first PUSCH is scheduled by a downlink control information (DCI) format, and
the DCI format indicates the second priority.

13. The UE of claim 8, wherein:
the transmission of the first PUSCH is configured by higher layer signaling, and
the higher layer signaling indicates the second priority.

14. The UE of claim 8, wherein the transceiver is further configured to:
transmit:
a second PUSCH, wherein the second PUSCH has the first priority, and
a third PUSCH, wherein the third PUSCH has the second priority, and
prioritize power allocation to the third PUSCH over the second PUSCH, wherein the second priority is larger than the first priority.

15. A base station comprising:
a processor configured to determine:
a first priority for a first physical uplink control channel (PUCCH) and a second priority for a first physical uplink shared channel (PUSCH), wherein;
the first priority is different than the second priority, and
the first PUCCH includes a first uplink control information (UCI), and
that a reception of the first PUCCH would overlap in time with a reception of the first PUSCH; and
a transceiver operably coupled to the processor, the transceiver configured to receive:
the first PUSCH when the second priority is larger than the first priority, wherein:
the first PUSCH includes the first UCI when the first UCI is first acknowledgement information, and
the first PUSCH does not include the first UCI when the first UCI is first channel state information, and
the first PUCCH when the first priority is larger than the second priority.

16. The base station of claim 15, wherein:
the processor is further configured to determine:
the first priority for a second PUCCH and the second priority for a third PUCCH,
that a reception of the second PUCCH would overlap in time with a reception of the third PUCCH, and
to receive the first PUCCH after resolving the time overlap of the second PUCCH and the third PUCCH, wherein:
the second PUCCH includes second acknowledgement information,
the third PUCCH includes third acknowledgement information and second channel state information.
the first PUCCH includes only the second acknowledgement information and the third acknowledgement information, and
the first priority is larger than the second priority.

17. The base station of claim 15, wherein the transceiver is further configured to transmit an indication to include a UCI in a PUSCH when a priority associated with the UCI is different than a priority associated with the PUSCH.

18. The base station of claim 15, wherein:
the processor is further configured to determine:
the second priority for a second PUSCH, and
that the reception of the first PUCCH would overlap in time with a reception of the second PUSCH; and
the transceiver is further configured to receive the first PUCCH, wherein:
the first PUSCH is on a first cell,
the second PUSCH is on a second cell that is different from the first cell,
the first PUCCH is on a third cell, and
the first priority is larger than the second priority.

19. The base station of claim 15, wherein:
the reception of the first PUSCH is scheduled by a downlink control information (DCI) format, and
the DCI format indicates the second priority.

20. The base station of claim 15, wherein:
the reception of the first PUSCH is configured by higher layer signaling, and
the higher layer signaling indicates the second priority.
